(19) United States
(12) Patent Application Publication
(10) Pub. No.: US 2008/0266103 A1
(43) Pub. Date: Oct. 30, 2008

(54) RADIO FREQUENCY IDENTIFICATION DEVICES

(75) Inventors: Ya-Ping Chen, Shilong Village (TW); Shao-Chang Chang, Hsinchu City (TW)

Correspondence Address: Akin Gump LLP - Silicon Valley, 3000 El Camino Real, Two Palo Alto Square, Suite 400, Palo Alto, CA, 94306, US

(73) Assignee: INDUSTRIAL TECHNOLOGY RESEARCH INSTITUTE, Hsinchu (TW)

(21) Appl. No.: 11/742,167

(22) Filed: Apr. 30, 2007

(51) Int. Cl. G08B 1/08

(52) U.S. Cl. 340/572.7

(57) ABSTRACT

A radio frequency identification device comprising a first antenna configured to receive and transmit radio frequency identification signals, the first antenna being configured to transmit and receive the signals at a first frequency, a controller configured to provide data for communication, a first mixer coupled with the controller and the first antenna, the first mixer being configured to modulate the data from the controller with a first signal having the first frequency, and a second mixer coupled with the controller and the first antenna, the second mixer being configured to demodulate received signals from the first antenna with a second signal having the first frequency.

### BACKGROUND OF THE INVENTION

The present invention generally relates to radio frequency identification (RFID) and, more particularly, to RFID devices capable of providing the functions of an RFID reader and an RFID tag.

Radio frequency identification (RFID) is a technology that may be used for various object, device or information identification purposes. RFID tags or labels are widely used to associate an object with an identification code. For example, RFID tags have been used for inventory management, access control to buildings and security-locks in vehicles. Information stored on an RFID tag may identify an item with a unique identification number or may identify a person seeking access to a secured building. RFID tags can also retain and transmit sufficient information to uniquely identify individuals, packages, inventory and the like. In an RFID system, in order to retrieve the information from an RFID tag, an RFID reader may send an excitation signal to the RFID tag using radio frequency (RF) data transmission technology. The excitation signal may energize the tag, which in turn may transmit or respond with the stored information back to the reader. The RFID reader may then receive and decode the information from the RFID tag.

RFID readers and RFID tags may include individual circuits and functions independent of one another. That is, an RFID reader may not function to serve as an RFID tag, and vice versa. Furthermore, conventional RFID devices may operate, for example, at a high-frequency (HF) band at or near 13.56 mega Hertz (MHz), or at an ultra-high-frequency (UHF) band in the range of 860 to 960 MHz. However, with the increasing interest in full-field communication, it may be desirable for certain applications to have an RFID device that may be able to operate at the above HF and UHF bands. It may also be desirable to have an RFID device that may include the functions of an RFID reader and an RFID tag in some applications.

### BRIEF SUMMARY OF THE INVENTION

Examples of the present invention may provide a radio frequency identification device comprising a first antenna configured to receive and transmit radio frequency identification signals, the first antenna being configured to transmit and receive the signals at a first frequency, a controller configured to provide data for communication, a first mixer coupled with the controller and the first antenna, the first mixer being configured to modulate the data from the controller with a first signal having the first frequency, and a second mixer coupled with the controller and the first antenna, the second mixer being configured to demodulate received signals from the first antenna with a second signal having the first frequency.

Examples of the present invention may further provide a radio frequency identification device comprising a first antenna capable of receiving and transmitting radio frequency identification signals, the first antenna being configured to transmit and receive the signals at a first frequency, a second antenna capable of transmitting radio frequency identification signals, the second antenna being configured to transmit the signals at a second frequency, the first frequency and the second frequency being different from one another, a controller configured to provide a control signal, and a synthesizer coupled with the controller and configured to generate at least one of a first signal having the first frequency or a second signal having the second frequency based on the control signal.

Examples of the present invention may provide a radio frequency identification device comprising a first antenna capable of receiving and transmitting radio frequency identification signals, the first antenna being configured to transmit and receive the signals at a first frequency, a second antenna capable of receiving and transmitting radio frequency identification signals, the second antenna being configured to transmit and receive the signals at a second frequency, the first frequency and the second frequency being different from one another, a controller configured to provide a control signal, a synthesizer coupled with the controller and configured to generate a first signal having the first frequency based on the control signal, and a transceiver coupled with the controller and configured to generate a second signal having the second frequency based on the control signal.

Some examples of the present invention may also provide a method of data communication, the method comprising identifying a first frequency for data communication, generating a first signal having the first frequency and a second signal having the first frequency, detecting whether an incoming signal is received, down-converting the incoming signal in frequency based on the second signal having the first frequency, and modulating data with the first signal having the first frequency.

Examples of the present invention may provide a method of data communication, the method comprising identifying a first frequency and a second frequency for data communication, transmitting a first signal having the first frequency through a first antenna to trigger a first radio frequency identification (RFID) device, and transmitting a second signal having the second frequency through a second antenna to trigger a second RFID device, wherein one of the first RFID device and the second RFID device includes a power supply module.

Examples of the present invention may also provide a method of data communication, the method comprising identifying a first frequency and a second frequency for data communication, the first frequency being different from the second frequency, modulating data with a first signal having the first frequency at a mixer, modulating data with a second signal having the second frequency at a transceiver, transmitting and receiving a first modulated signal having the first frequency through a first antenna, and transmitting and receiving a second modulated signal having the second frequency through a second antenna.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings examples which are presently preferred. It should be understood, however, that the invention is not limited to the precise arrangements and instrumentalities shown.

In the drawings:

FIG. 1A is a block diagram of a radio frequency identification (RFID) device consistent with an example of the present invention;

FIG. 1B is a flow diagram illustrating a method of data communication consistent with an example of the present invention;

FIG. 2A is a block diagram of an RFID device consistent with another example of the present invention;

FIG. 2B is a flow diagram illustrating a method of data communication consistent with another example of the present invention;

FIG. 3A is a block diagram of an RFID device consistent with still another example of the present invention;

FIG. 3B is a flow diagram illustrating a method of data communication consistent with still another example of the present invention; and

FIG. 4 is a block diagram of an RFID device consistent with yet another example of the present invention.

### DETAILED DESCRIPTION OF THE INVENTION

Reference will now be made in detail to the present examples of the invention illustrated in the accompanying drawings. Wherever possible, the same reference numbers will be used throughout the drawings to refer to the same or like portions.

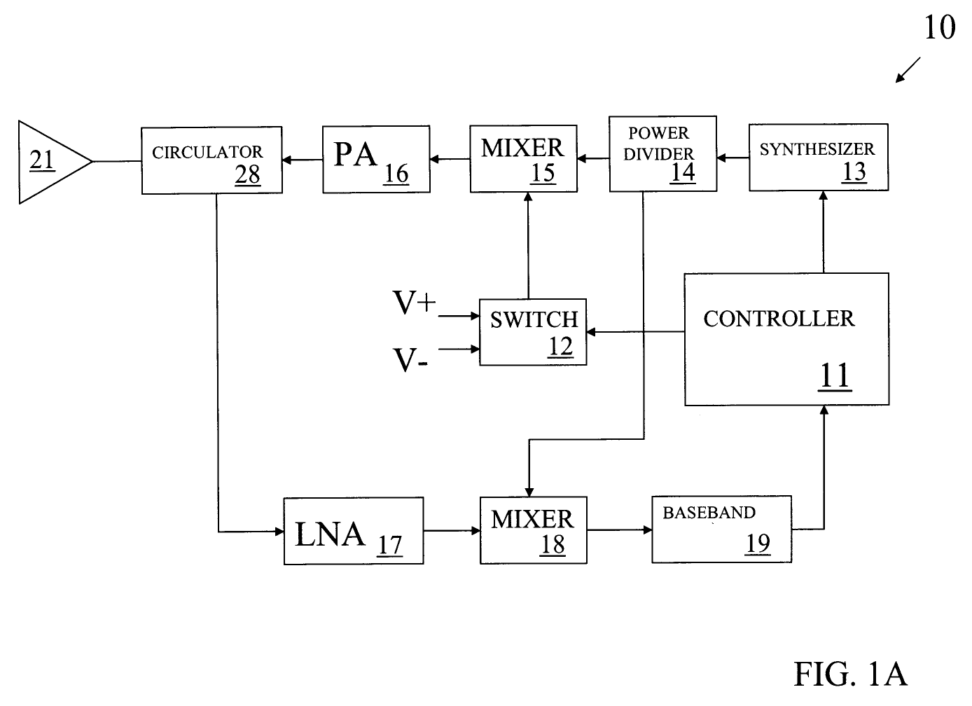

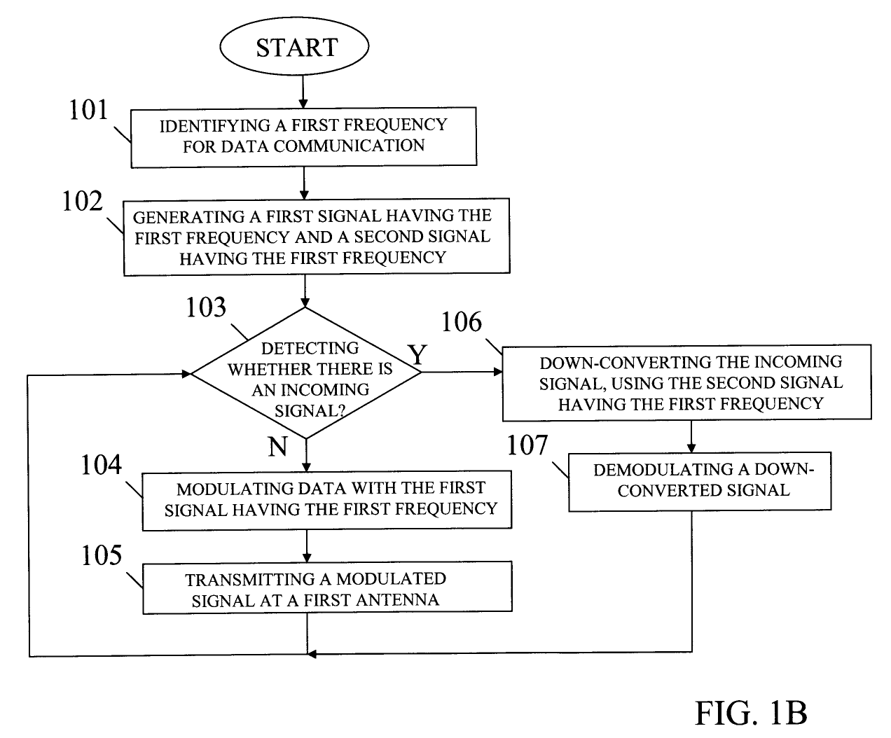

FIG. 1A is a block diagram of a radio frequency identification (RFID) device 10 consistent with an example of the present invention. Referring to FIG. 1A, the RFID device 10 may include a controller 11, a switch 12, a reader section capable of supporting RFID reader function, and a tag section capable of support RFID tag functions. The reader section may further include a synthesizer 13, a power divider 14, a first mixer 15 and a first amplifier such as a power amplifier (PA) 16. The tag section may further include a second amplifier such as a low-noise amplifier (LNA) 17, a second mixer 18 and a baseband module 19. The RFID device 10 may further include a circulator 28 and a first antenna 21. The circulator 28 may provide isolation effects of, for example, approximately 20 to 30 dB, so as to prevent outgoing signals provided by the reader section from entering the tag section, and to prevent incoming signals received at the first antenna 20 from entering the reader section.

With respect to the reader operation, the controller 11 such as, for example, a micro processor, may provide a first control signal to the synthesizer 13 and a second control signal to the switch 12 to turn on or turn off the switch 12. In response to the first control signal, the synthesizer 13 may generate a signal having a first frequency. In one example, the first frequency is approximately 915.4 MHz, which is at the UHF band. Passive RFID tags currently available in the market may be designed to receive and transmit signals at or near 915.4 MHz, while active RFID tags may be designed to receive signals at or near 433 MHz and transmit signals at or near 915.4 MHz. Generally, a passive RFID tag may refer to one that receives energy from a corresponding RFID reader, and an active RFID tag may refer to one that includes a power module such as a battery to generate the required energy. The first frequency may be used to trigger corresponding RFID tags. Furthermore, the 915.4-MHz frequency may therefore facilitate the use of passive RFID tags currently available in the market.

The signal from the synthesizer 13 may then be divided in power such as in half, for example, at the power divider 14 without changing the first frequency. The power divider 14 may provide a first signal having a first divided power level and the first frequency to the first mixer 15, and a second signal having a second divided power level and the first frequency to the second mixer 18. During the reader operation, the switch 12 may be turned on to enable modulation of data with the first signal. The data such as commands for example, may be sent from the controller 11 via the switch 12 to the first mixer 15. The modulation may include, but is not limited to, one of an amplitude-shift keying (ASK) and a phase-shift keying (PSK) modulation, based on a first voltage level v+ or a second voltage level v− from a power generation module (not shown). A modulated signal from the first mixer 15 may be provided to the first amplifier 16 for power amplification and then sent through the circulator 28 to the first antenna 21 for transmission.

With respect to the tag operation, a modulated incoming signal may be received at the first antenna 21 and sent to the LNA 17 through the circulator 28. The controller 11 may turn off the switch 12 in response to the incoming signal detected at the first antenna 21. The incoming signal, which has a second frequency, may be amplified at the LNA 17 and down-converted in frequency at the second mixer 18 based on the first frequency from the power divider 14. In one example, the second frequency may be substantially equal to the first frequency. That is, in the case that the first frequency is approximately 915.4 MHz used during the reader operation, the second frequency may also be approximately 915.4 MHz. A down-converted signal may then be provided from the second mixer 18 to the baseband module 19 for demodulation. The baseband module 19 may include circuits comprising amplifiers, buffers and comparators in one example. A demodulated signal may then be sent to the controller 11 for subsequent processing.

FIG. 1B is a flow diagram illustrating a method of data communication consistent with an example of the present invention. Referring to FIG. 1B and also referring to FIG. 1A, at step 101, a first frequency for data communication may be identified. At step 102, a first signal having the first frequency and a second signal having the first frequency may be generated. Next, at step 103, it may be detected whether an incoming signal is received at a first antenna. If not, data such as commands may be modulated with the first signal at step 104, and a modulated signal may then be transmitted at the first antenna at step 105. If confirmative, the incoming signal may be down-converted at step 106 using the second signal having the first frequency, and a down-converted signal may then be demodulated at step 107.

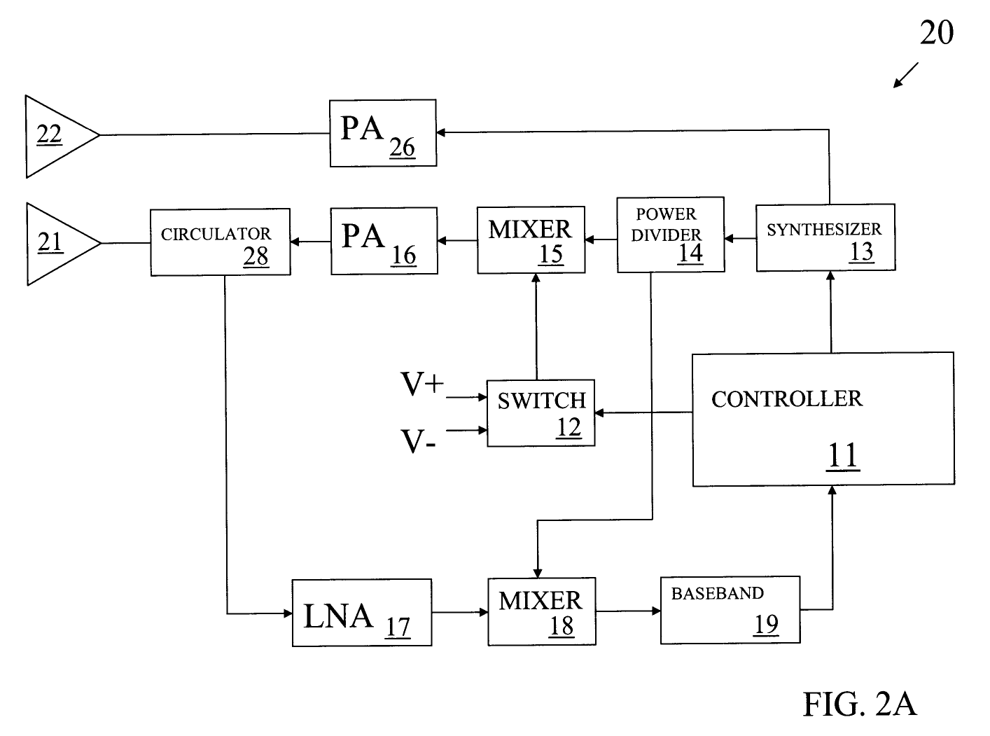

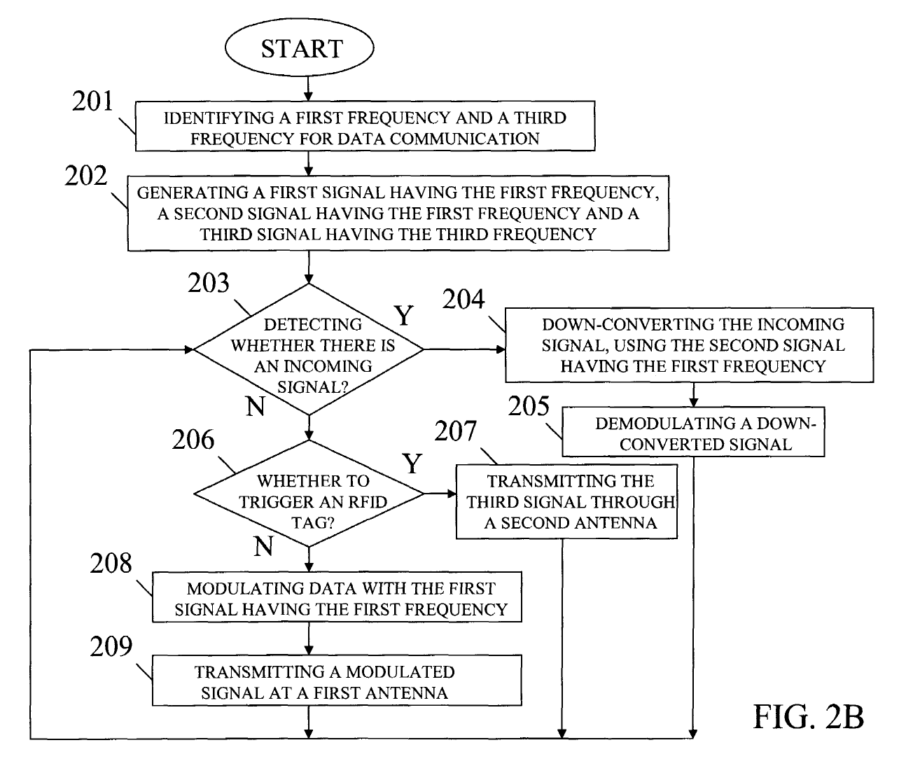

FIG. 2A is a block diagram of an RFID device 20 consistent with another example of the present invention. Referring to FIG. 2A, the RFID device 20 may be similar to the RFID device 10 illustrated in FIG. 1A except for the addition of a second power amplifier (PA) 26 and a second antenna 22. With respect to the reader operation, the synthesizer 13, in addition to generating the signal having the first frequency, may generate another signal having a third frequency. The third frequency, which may be different from the first frequency, may be used to trigger active RFID tags. In one example, the first frequency may be approximately 915.4 MHz, and the third frequency may be approximately 457.7 MHz, or half of the first frequency, which may facilitate the design of a frequency divider circuit (not shown). In another example, the first frequency may be approximately 915.4 MHz, and the third frequency may be approximately 433 MHz, which may facilitate the use of active RFID tags currently available in the market. The signal having the third frequency may be amplified at the second PA 26 and then transmitted through the second antenna 22.

With respect to the tag operation, an incoming signal from either a passive RFID tag or an active RFID tag may include the second frequency. In one example, a passive RFID tag may be configured to receive and transmit signals at or near 915.4 MHz, while an active RFID tag may be configured to receive signals at or near 433 MHz and transmit signals at or near 915.4 MHz.

FIG. 2B is a flow diagram illustrating a method of data communication consistent with another example of the present invention. Referring to FIG. 2B and also referring to FIG. 2A, at step 201, a first frequency and a third frequency for data communication may be identified. At step 202, a first signal having the first frequency, a second signal having the first frequency and a third signal having the third frequency may be generated. In one example, the first signal and the third signal may be used to trigger a passive RFID tag and an active RFID tag, respectively. Next at step 203, it may be detected whether an incoming signal is received at a first antenna. If confirmative, the incoming signal may be down-converted at step 204 using the second signal having the first frequency, and a down-converted signal may then be demodulated at step 205. If not, it may be determined whether to trigger an RFID tag such as, for example, an active RFID tag at step 206. If confirmative, at step 207, the third signal may be transmitted through a second antenna to trigger the RFID tag. If not, data such as commands may be modulated with the first signal at step 208, and a modulated signal may then be transmitted at the first antenna at step 209 to trigger, for example, a passive RFID antenna.

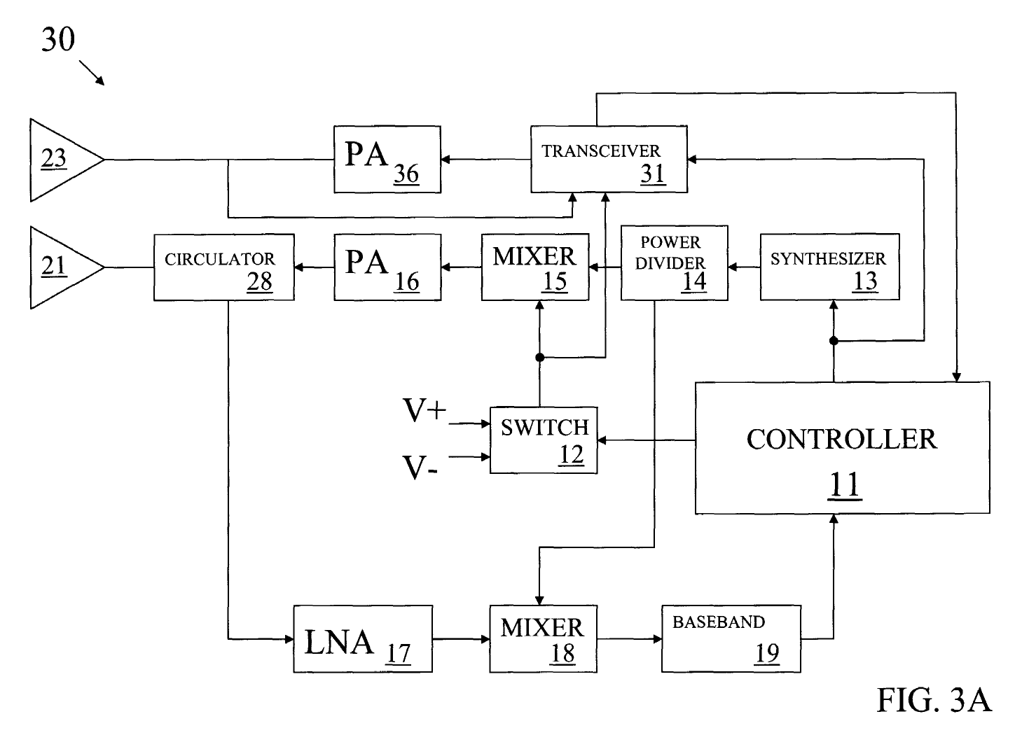

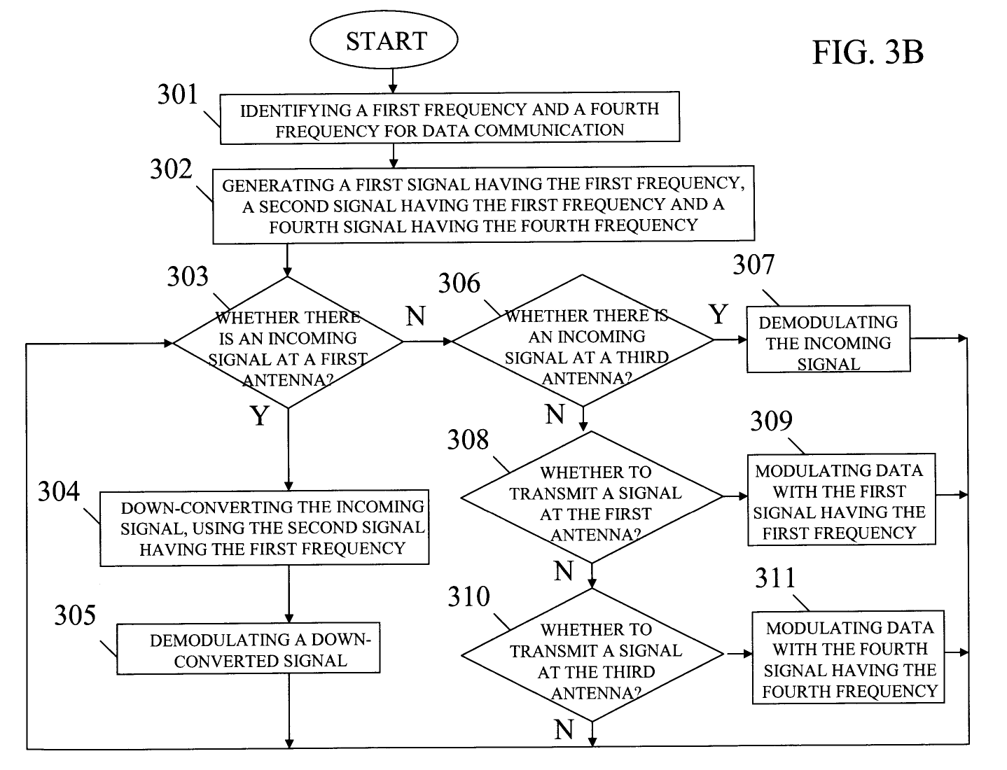

FIG. 3A is a block diagram of an RFID device 30 consistent with still another example of the present invention. Referring to FIG. 3A, the RFID device 30 may be similar to the RFID device 10 illustrated in FIG. 1A except the addition of a transceiver 31, a third power amplifier (PA) 36 and a third antenna 23. With respect to the reader operation, the controller 11 may send the first control signal to the transceiver 31 as well as to the synthesizer 13 to enable at least one of the transceiver 31 or the synthesizer 13. Furthermore, the switch 12 may be turned on to enable modulation of data from the controller 11 at the transceiver 31. The modulation may include but is not limited, to one of ASK and PSK modulation. The transceiver 31 may provide a modulated signal having a fourth frequency of, for example, approximately 13.56 MHz. The modulated signal may then be transmitted through the third antenna 23.

With respect to the tag operation, a first incoming signal having the first frequency may be received at the first antenna 21 and sent through the circulator 28, LNA 17, second mixer 18 and baseband module 19 to the controller 11. The first frequency in one example may include a UHF component. Furthermore, a second incoming signal having the fourth frequency may be received at the third antenna 23 and sent to the transceiver 31 for demodulation. A demodulated signal, which may be a digital signal, may then be sent to the controller 11 for subsequent processing such as decoding. The third frequency in one example may include a 13.56 MHz-frequency component.

FIG. 3B is a flow diagram illustrating a method of data communication consistent with still another example of the present invention. Referring to FIG. 3B and also referring to FIG. 3A, at step 301, a first frequency and a fourth frequency for data communication may be identified. At step 302, a first signal having the first frequency, a second signal having the first frequency and a fourth signal having the fourth frequency may be generated. Next at step 303, it may be detected whether an incoming signal is received at a first antenna. If confirmative, the incoming signal may be down-converted at step 304 using the second signal having the first frequency, and a down-converted signal may then be demodulated at step 305. If not, at step 306 it may be detected whether an incoming signal is received at a second antenna. If confirmative, at step 307 the incoming signal may be demodulated and then decoded. If not, at step 308 it may be determined whether a signal is to be transmitted at the first antenna. If confirmative, at step 309 data such as commands may be modulated with the first signal having the first frequency, and then a modulated signal may be transmitted through the first antenna. If not, at step 310 it may be determined whether a signal is to be transmitted at the second antenna. If confirmative, at step 311 data such as commands may be modulated with the fourth signal having the fourth frequency, and then a modulated signal may be transmitted through the second antenna. If not, the step 303 may be repeated.

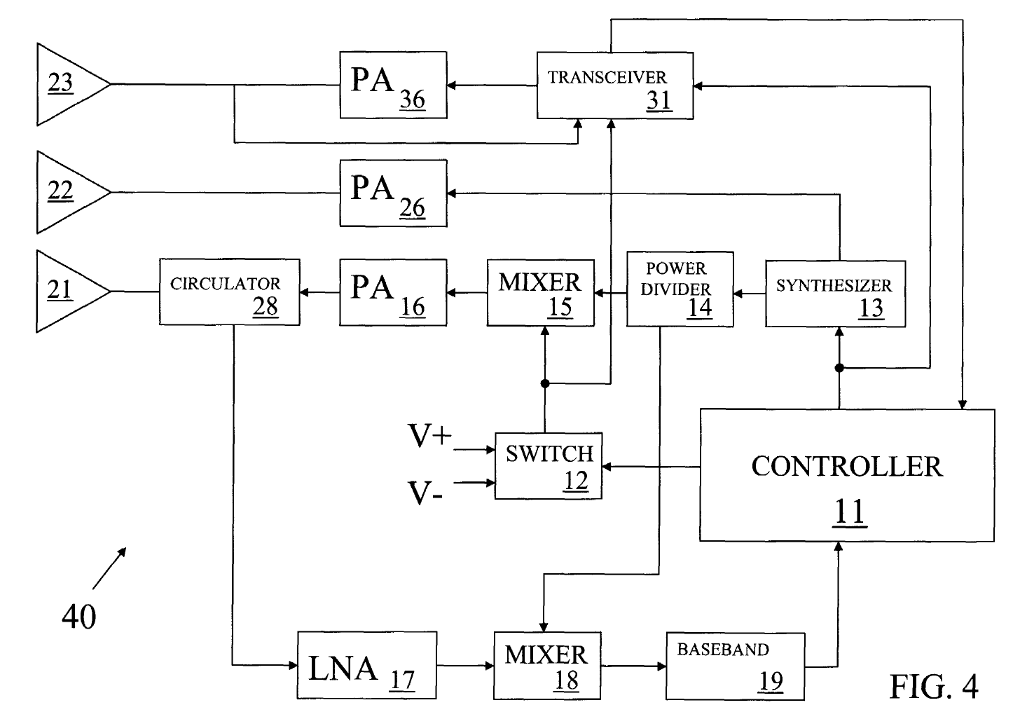

FIG. 4 is a block diagram of an RFID device 40 consistent with yet another example of the present invention. Referring to FIG. 4, the RFID device 40 may be similar to the RFID device 20 illustrated in FIG. 2A and the RFID device 30 illustrated in FIG. 3A in combination. In one example consistent with the present invention, the RFID device 40 may transmit and receive signals having a first frequency through the first antenna 21. The first frequency may include one at the UHF band, such as, for example, 915.4 MHz. Furthermore, the RFID device 40 may transmit signals having a second frequency to trigger an active RFID tag through the second antenna 22. The second frequency may include one at the UHF band, such as 433 MHz. Moreover, the RFID device 40 may transmit and receive signals having a third frequency through the third antenna 23. The third frequency may include 13.56 MHz. Methods of operating the RFID device 40 may be similar to those illustrated in FIGS. 2A and 3A and need not be discussed.

In describing representative examples of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

We claim:

1. A radio frequency identification device comprising:
a first antenna configured to receive and transmit radio frequency identification signals, the first antenna being configured to transmit and receive the signals at a first frequency;
a controller configured to provide data for communication;
a first mixer coupled with the controller and the first antenna, the first mixer being configured to modulate the data from the controller with a first signal having the first frequency; and
a second mixer coupled with the controller and the first antenna, the second mixer being configured to demodulate received signals from the first antenna with a second signal having the first frequency.

2. The device of claim 1 further comprising a synthesizer coupled with the controller and configured to generate a signal having the first frequency.

3. The device of claim 2 further comprising a power divider coupled with the synthesizer and configured to generate the first signal having the first frequency and the second signal having the first frequency based on the signal from the synthesizer.

4. The device of claim 1 further comprising a switch coupled between the controller and the first antenna, wherein the controller turns on the switch during a period for signal transmission through the first antenna and turns off the switch during a period for signal receiving through the first antenna.

5. The device of claim 1 further comprising a second antenna configured to transmit signals having a second frequency.

6. The device of claim 5, wherein at least one of the first frequency and the second frequency is in an ultra high frequency (UHF) band.

7. The device of claim 6, wherein the first frequency is approximately 915.4 MHz, and the second frequency is approximately 433 MHz.

8. The device of claim 1 further comprising a transceiver coupled to the controller and configured to modulate the data with a third signal having a second frequency.

9. The device of claim 8 further comprising a third antenna coupled with the transceiver and configured to transmit and receive signals having the third frequency.

10. The device of claim 9, wherein the third frequency is approximately 13.56 MHz.

11. A radio frequency identification device comprising:
a first antenna capable of receiving and transmitting radio frequency identification signals, the first antenna being configured to transmit and receive the signals at a first frequency;
a second antenna capable of transmitting radio frequency identification signals, the second antenna being configured to transmit the signals at a second frequency, the first frequency and the second frequency being different from one another;
a controller configured to provide a control signal; and
a synthesizer coupled with the controller and configured to generate at least one of a first signal having the first frequency or a second signal having the second frequency based on the control signal.

12. The device of claim 11 further comprising a switch coupled with the controller, wherein the controller turns on the switch during a period for signal transmission through the first antenna and turns off the switch during a period for signal receiving through the first antenna.

13. The device of claim 11 further comprising a first mixer coupled with the controller and configured to modulate data from the controller based on the first frequency.

14. The device of claim 11 further comprising a second mixer coupled with the controller and configured to demodulate signals received through the first antenna based on the first frequency.

15. The device of claim 11 further comprising a circulator coupled between the first antenna and the synthesizer.

16. The device of claim 11 further comprising a transceiver coupled to the controller and configured to modulate data from the controller at a third frequency.

17. The device of claim 16 further comprising a third antenna coupled with the transceiver and configured to transmit and receive signals having the third frequency.

18. A radio frequency identification device comprising:
a first antenna capable of receiving and transmitting radio frequency identification signals, the first antenna being configured to transmit and receive the signals at a first frequency;
a second antenna capable of receiving and transmitting radio frequency identification signals, the second antenna being configured to transmit and receive the signals at a second frequency, the first frequency and the second frequency being different from one another;
a controller configured to provide a control signal;
a synthesizer coupled with the controller and configured to generate a first signal having the first frequency based on the control signal; and
a transceiver coupled with the controller and configured to generate a second signal having the second frequency based on the control signal.

19. The device of claim 18 further comprising a switch coupled with the controller, wherein the controller provides data for communication via the switch to the transceiver.

20. The device of claim 19, wherein the transceiver modulates the data from the controller with the second signal having the second frequency.

21. The device of claim 18 further comprising a first mixer coupled with the controller, wherein the controller provides data for communication via the switch to the first mixer.

22. The device of claim 21, wherein the first mixer modulates the data from the controller with the first signal having the first frequency.

23. The device of claim 18 further comprising a second mixer coupled with the controller and configured to demodulate signals received through the first antenna based on the first frequency.

24. The device of claim 18 further comprising a third antenna capable of receiving and transmitting radio frequency signals, wherein the third antenna is configured to transmit the signals at a third frequency, the third frequency being different from the first frequency and the second frequency.

25. The device of claim 24, wherein the synthesizer is configured to generate at least one of the first signal having the first frequency or a third signal having the third frequency based on the control signal.
